(19) United States
(12) Patent Application Publication
(10) Pub. No.: US 2005/0053353 A1
(43) Pub. Date: Mar. 10, 2005

(54) Personal video recorder and method for controlling the same

(75) Inventor: Jong Yeul Suh, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/912,065

(22) Filed: Aug. 6, 2004

(30) Foreign Application Priority Data
Aug. 9, 2003 (KR) P2003-55177

(51) Int. Cl. H04N 5/781

(52) U.S. Cl. 386/46; 386/125

(57) ABSTRACT

Disclosed is a private video recorder (PVR) for processing and storing data provided from an external apparatus such as a visual telephone and an interphone. The PVR includes: a broadcasting signal processing part for detecting a video feature from a received broadcasting stream and generating an index file having the detected video feature; an external signal processing part for converting a signal provided from an external image apparatus, into an MPEG stream; and a controller for storing, in predetermined areas inside a storing means, the broadcasting stream and the index file provided from the broadcasting signal processing part, and the MPEG stream provided from the external signal processing part, respectively.

This application claims the benefit of the Korean Application No. P2003-55177 filed on Aug. 9, 2003, which is hereby incorporated by reference.

### BACKGROUND OF THE INVENTION

1. Field of the Invention

The present invention relates to a personal video recorder (PVR), and more particularly, to a PVR processing and storing data provided from an external device such as a visual telephone and an interphone, and a method for controlling the same.

2. Discussion of the Related Art

In the home appliances such as a digital TV (television), a digital camcorder, an encoder such as an MPEG (moving picture experts group) is used for reducing a storage capacity and a transmission capacity of a digital video or audio. Particularly, a digital storing method using a digital storing medium such as an HDD (hard disk drive) or a DVD (digital video disk), not an analog storing method using the conventional VTR (video tape recorder), is currently used for an apparatus such as a digital TV and a STB (set top box).

A digital camcorder requires an encoder having a complicated standard of an MPEG series and should include both an encoder and a decoder. Recently, a simple compression encoding standard is developed to overcome a problem of the encoder of the MPEG series which should estimate a movement and compute a complement thereof. The encoding standard of a digital camcorder is disclosed in International standard CEI/IEC 61834-2, Recording—Helical-scan digital video cassette recording system using 6.35 mm magnetic tape for consumer use (525-60, 625-50, 1125-60 and 1250-50 systems)—Part 2: SD format for 525-60 and 625-50 systems, and the encoding standard of a digital camcorder is generally called a DV (digital video).

The function of the conventional PVR is mainly limited to storing a TV program of other channel while one program is watched, or to allowing a user possibly to watch a TV program stored in a HDD using its time-shift function, or to storing and playing a digital TV signal to and from a HDD. With such a trend, a demand for a PVR device having functions of processing and storing various external input signals from a digital camcorder or a digital camera is increasing. Also, recently, there emerge user's needs to store a moving image provided from a CCTV (closed circuit TV), a visual telephone, and an interphone.

### SUMMARY OF THE INVENTION

Accordingly, the present invention is directed to a PVR (private video recorder) and method for controlling the same that substantially obviates one or more problems due to limitations and disadvantages of the related art.

An object of the present invention is to provide a PVR system and method for controlling the same, which is adapted for processing and storing data provided from an external apparatus such as a visual telephone and an interphone.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a personal video recorder including: a broadcasting signal processing part for detecting a video feature from a received broadcasting stream and generating an index file having the detected video feature; an external signal processing part for converting a signal provided from an external image apparatus, into an MPEG stream; and a controller for storing, in predetermined areas inside a storing means, the broadcasting stream and the index file provided from the broadcasting signal processing part, and the MPEG stream provided from the external signal processing part, respectively.

Here, the broadcasting signal processing part includes: a decoder for detecting an elementary stream in the broadcasting stream; an index generating/vF extracting means for detecting a video feature from the detected elementary stream and generating an index file having the detected video feature; and a download control part for adding a time stamp to the broadcasting stream provided from the decoder. At this point, the download control part adds the time stamp to the broadcasting stream on the basis of a clock reference included in the broadcasting stream.

The video feature includes at least one of an image's capacity and an image's type included in the broadcasting stream, and the index file further includes a storing address of the broadcasting stream.

The external signal processing part includes: a transcoder for converting a signal provided from a visual telephone into an MPEG stream; and an encoder for converting a signal provided from an intercommunication system, into an MPEG stream.

The controller includes: an interface for storing, in a storing means, the broadcasting stream and the index file provided from the broadcasting signal processing part, and the MPEG stream provided from the external signal processing part; an upload control part for outputting, in a predetermined bit rate, the stream stored in the storing means. The controller outputs the broadcasting stream stored in the storing means in a bit rate based on a time stamp added to the broadcasting stream, and outputs the MPEG stream stored in the storing means in a bit rate based on a clock reference included in the MPEG stream.

In another aspect of the present invention, a method for controlling the PVR, includes the steps of: detecting a video feature from a received broadcasting stream and generating an index file having the detected video feature; adding a time stamp to the broadcasting stream; converting a signal provided from an external image apparatus, into an MPEG stream; and storing, in predetermined areas inside the storing means, the broadcasting stream to which the time stamp is added, the index file, and the MPEG stream, respectively.

The method for controlling the PVR, further includes the steps of: outputting the broadcasting stream stored in the storing means, in a bit rate based on the time stamp added to the broadcasting stream; and outputting the MPEG stream stored in the storing means, in a bit rate based on a clock reference included in the MPEG stream.

In still another aspect of the present invention, a personal video recorder includes: a broadcasting processing part for converting a received broadcasting signal into a broadcasting stream; an external signal processing part for converting a signal provided from an external image apparatus, into an MPEG stream; and a controller for storing, in a storing means, the broadcasting stream to which a time stamp is added, and the MPEG stream, outputting the broadcasting stream stored in the storing means in a bit rate based the time stamp added to the broadcasting stream, and outputting the MPEG stream stored in the storing means in a bit rate based on a clock reference included in the MPEG stream.

The controller detects a video feature from a broadcasting stream provided from the broadcasting signal processing part and generates an index file including the detected video feature.

In a further another aspect of the present invention, a method for controlling the PVR, includes the steps of: adding a time stamp to a received broadcasting stream; storing the broadcasting stream to which the time stamp is added, in a storing means; converting a signal provided from an external image apparatus, into an MPEG stream, and storing the same in the storing means; outputting the broadcasting stream stored in the storing means, in a bit rate based on the time stamp added to the broadcasting stream; and outputting the MPEG stream stored in the storing means, in a bit rate based on a clock reference included in the MPEG stream.

The above method may further include the steps of: detecting a video feature from the broadcasting stream; and generating an index file having the detected video feature.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated and constitute a part of this application, illustrate embodiment(s) of the invention and together with the description serve to explain the principle of the invention. In the drawings:

FIG. 1 is a block diagram showing a construction of a PVR according to a first embodiment of the present invention;

FIG. 2 is a flowchart showing a method for controlling a PVR according to a first embodiment of the present invention;

FIG. 3 is a block diagram showing a construction of a PVR according to a second embodiment of the present invention;

FIG. 4 is a view showing a storing means which is divided for each area; and

FIG. 5 is a flowchart showing a method for controlling a PVR according to a second embodiment of the present invention;

### DETAILED DESCRIPTION OF THE INVENTION

Reference will now be made in detail to the preferred embodiments of the present invention, examples of which are illustrated in the accompanying drawings.

First Embodiment

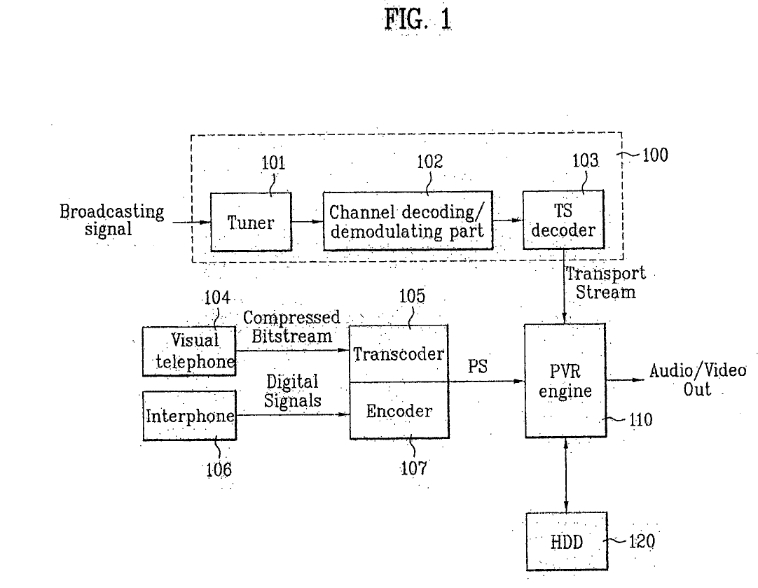

FIG. 1 is a block diagram exemplarily showing a home network system including a personal video recorder (PVR) of the present invention. The PVR of the present invention includes a broadcasting signal processing part 100 which can be realized by one chip. As shown in FIG. 1, the broadcasting signal processing part 100 includes: a tuner 101 for selecting a broadcasting signal; a decoding and demodulating part 102 for decoding and demodulating a signal output from the tuner 101; and a transport stream (TS) decoder 103 for detecting a transport stream from the demodulated signal.

The PVR of the present invention is wired/wireless-connected with an external apparatus such as a visual telephone 104 and an intercommunication system 106, and receives data including an image and a voice from these external apparatus. For example, data received from the visual telephone 104 is provided to the transcoder 105. The data provided to the transcoder 105 from the visual telephone 104 is a compressed bit stream appropriate for transmission of multimedia data. Namely, the data is a bit stream compressed by a compression method such as an ITU H.263 or an MPEG-4 appropriate for environment of a low transmission rate, not an MPEG-1 or an MPEG-2 for use in a digital broadcasting. Therefore, the transcoder 105 converts the compressed bit stream into an MPEG-2 bit stream. If the data provided to the PVR from the visual telephone 104 is data of an MPEG-1 or an MPEG-2 format, the transcoder 105 may be omitted.

In another example, image and audio data obtained by the intercommunication system 106 or an interphone installed in an outside of the house, is provided to an encoder 107. The intercommunication system 106 converts a moving image and a voice of a visitor obtained by a camera and a microphone, into digital signals. Also, the encoder 107 converts the converted digital signal into an MPEG-2 bit stream. More specifically, the encoder 107 compresses a moving image obtained by a digital camera of hundred thousand pixels, in an MPEG-2 MP@LL(main profile @ low level), and converts the same in a resolution of 352×288. In case an MPEG-2 encoder is mounted inside the intercommunication system 106, the PVR may not include the encoder 107.

A PVR controller 110 receives a transport stream from the broadcasting signal processing part 100, receives MPEG-2 bit streams from the transcoder 105 and the encoder 107, and stores the received streams in a strong means such as an HDD 120. The PVR controller 110 detects a video feature from the received transport stream. The video feature includes header information such as a sequence header, a picture header included in the transport stream, and a capacity and a type of an image, extracted from a macroblock information. The PVR controller 110 assigns a storing address of the streams when storing the received streams in the HDD 120. Also, the PVR controller 110 searches data stored in the HDD 120 and decodes the data to play a recorded image. The PVR controller 110 may be used for a system where a digital TV and the PVR is combined.

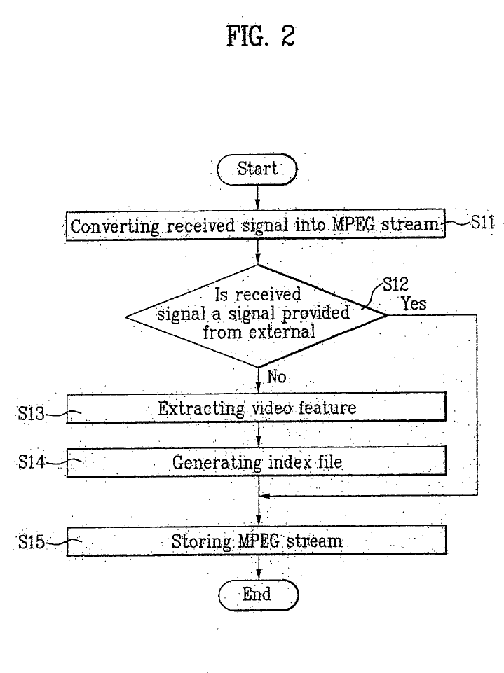

The method for controlling the PVR according to the present invention will be described in the following. FIG. 2 is a flowchart explaining a process for storing an image signal of an external apparatus. The PVR of the present invention receives signals including an image and a voice from the visual telephone 104 and/or the intercommunication system 106 for example. As shown in FIG. 2, a signal provided from the visual telephone 104 is converted into an MPEG stream by the transcoder 105 and a signal provided from the intercommunication system 106 is converted into an MPEG stream by the encoder 107 (S11).

The PVR controller 110 receives a transport stream from the broadcasting signal processing part 100 and receives MPEG streams from the transcoder 105 and/or the encoder 107. Also, the PVR controller 110 judges whether the received stream is a broadcasting signal or a signal received from an external apparatus (S12).

If the received stream is a broadcasting signal, the PVR controller 110 adds a time stamp to the received transport stream. The time stamp represents a time when the transport stream is received. The reason why the time stamp is added to the transport stream is to prevent a decoding error of an MPEG decoder due to an overflow or an underflow of an MPEG decoder buffer (not shown). The PVR controller 110 extracts header information (e.g., sequence_header, picture_header) from the transport stream and macroblock information (e.g., scene interval division information, movement vector information), and obtains a video feature from the above information (S13). Also, the PVR controller 110 generates an index file that corresponds to the transport stream on the basis of the video feature (S14). The index file includes a capacity of the transport stream, a picture type included in the transport stream, and information related to a storing address of the transport stream, and is related to an image content feature so as to support editing an image or a broadcasting program stored in the HDD 120, rapid playback, reverse playback, shot detection, scene segmentation, intelligent playback. The PVR controller 110 sets a storing address of the transport stream and stores the transport stream together with the index file in the HDD 120 (S15). When outputting/playing the transport stream stored in the HDD 120, the PVR controller 110 outputs the transport stream while maintaining a constant output bit rate, by referring to the time stamp added to the transport stream. At this point, the time stamp is removed from the transport stream.

If the received stream is a stream provided from an external apparatus, the PVR controller 110 identifies whether the received stream is an MPEG stream received from the visual telephone 104 or the intercommunication system 106. Since an amount of the MPEG streams received from the visual telephone 104 and the intercommunication system 106 is about 30 seconds to 1 minute, it is meaningless to trick play the received MPEG streams. Therefore, a video feature that corresponds to the MPEG stream is not extracted and an index file is not generated. Since a capacity of the MPEG stream is small, an output bit rate can be controlled even if a time stamp is not added. The output bit rate of the MPEG stream may be adjusted by controlling a buffer without the time stamp. If a stream is received from other external apparatus, e.g., a camcorder, a DVD, not the visual telephone 104, or the intercommunication system 106, a capacity of the received stream becomes large, so that a time stamp is added to the stream and an index file thereof is generated. The PVR controller 110 assigns an address at the stream received from the external apparatus according to a user's command, and stores the same in the HDD 120. Particularly, while a user is out, an image received from the visual telephone 104 or the intercommunication system 106 can be stored.

Second Embodiment

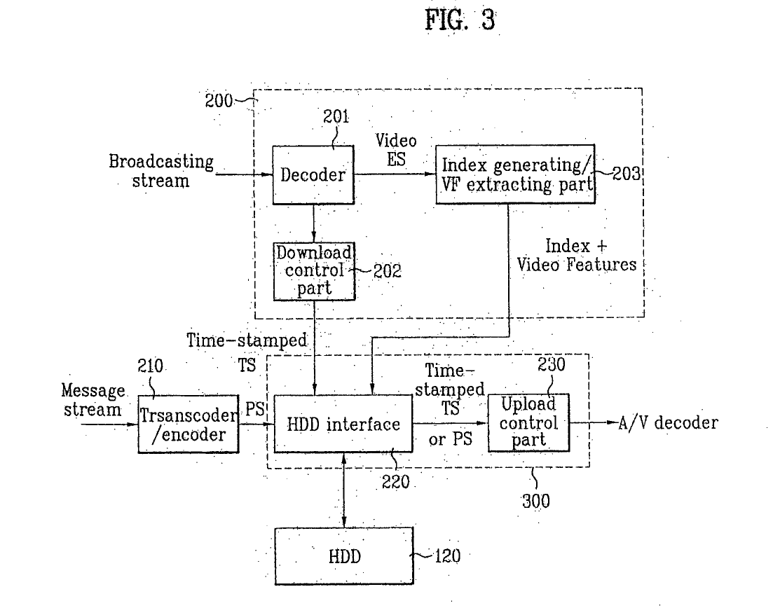

FIG. 3 is a block diagram showing a construction of a PVR according to a second embodiment of the present invention. As shown in FIG. 3, a broadcasting signal processing part 200 includes: a decoder 201; an index generating/video feature (VE) extracting means 203; and a download control part 202. The decoder 201 extracts a video elementary stream (video ES) or a packetized elementary stream (PES) from the received transport stream, and provides the same to the index generating/VF extracting means 203. The index generating/VF extracting means 203 extracts a video feature from the stream provided from the decoder 201, and generates an index file on the basis of the extracted video feature. Also, the index generating/VF extracting means 203 detects position information of picture start codes included in the stored stream and divides a scene interval so as to trick play a stream stored in the HDD 120, and detects histogram information in a frame unit so as to extract movement information. The download control part 202 gives a time stamp to a transport stream on the basis of a system clock value of each packet included in the transport stream when receiving the transport stream provided from the decoder 201.

An external signal processing part 210 includes: a transcoder for converting a signal provided from a visual telephone, into a program stream (PS) in form of an MPEG-2; and an encoder for converting a signal provided from an intercommunication system, into the PS in form of an MPEG-2.

The PVR controller 300 includes an HDD interface 220 and an upload control part 230. The HDD interface 220 is provided with a stream related to a broadcasting signal from the download control part 202, and is provided with an index file from the index generating/VF extracting means 203. Also, the HDD interface 220 is provided with an MPEG stream of an external apparatus from the external signal processing part 210. The HDD interface 220 stores a stream provided from the download control part 202 in the HDD 120 according to a storing address included in the index file, and stores the MPEG stream in the HDD 120. The HDD interface 220 is either an integrated drive electronics interface (IDE interface) or an enhanced integrated drive electronics interface (EIDE interface). The upload control part 230 reads a stream stored in the HDD 120 and outputs the stream to A/V (audio and video) decoder or an MPEG decoder in a constant bit rate on the basis of a time stamp added to the stream. At this point, the upload control part 230 removes the time stamp from the stream.

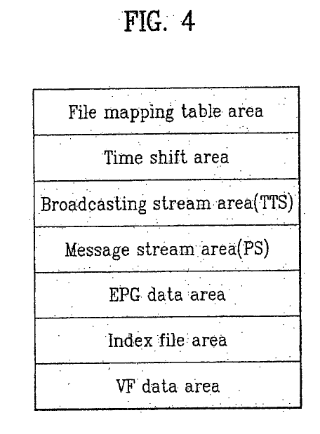

FIG. 4 is a view showing an example of the HDD 120 including divided areas. As shown in FIG. 4, a broadcasting stream area is an area where a time-stamped transport stream output from the download control part 202 is stored and a message stream area is an area where a program stream output from the external signal processing part 210 is stored. A file mapping table area is an area where crucial information for managing the whole file system inside the HDD 120 is stored. Physical information related to whole area division of the HDD 120 and a table representing a physical location of each file are stored in the file mapping table area. In other words, the file mapping table area plays the same role as an area where a file allocation table (FAT) for use in a DOS (disk operating system). Also, the HDD 120 includes an area where data related to an electronic program guide (EPG) is stored, an area where an index file is stored, and an area where data related to a video feature is stored.

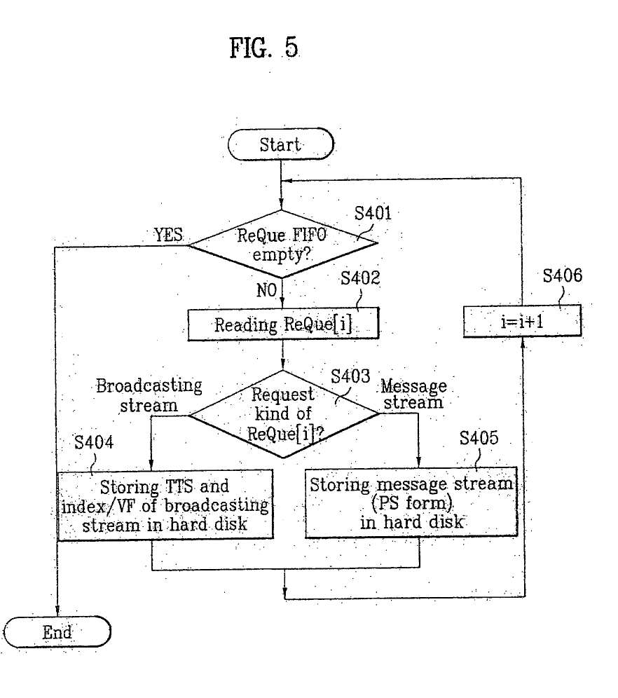

The method for controlling PVR according to a second embodiment of the present invention will be described in the following. FIG. 5 is a flowchart explaining a process for storing an image signal from an external apparatus and a broadcasting signal. The PVR of the present invention receives signals including an image and a voice from the visual telephone and/or the intercommunication system. The signal provided from the visual telephone and/or the intercommunication system are converted into an MPEG stream by the external signal processing part 210.

Also, the PVR of the present invention receives a broadcasting signal. The decoder 201 extracts a video elementary stream (video ES) or a packetized elementary stream (PES) from the received broadcasting signal, and provides the same to the index generating/VF extracting means 203. Then, the index generating/VF extracting means 203 detects a video feature from the elementary stream and generates an index file on the basis of the detected video feature. The download control part 202 outputs a transport stream to which a time stamp is added.

The HDD interface 220 receives a stream from the broadcasting signal processing part 200 or the external signal processing part 210, and sequentially stores requests that correspond to the received stream in a FIFO (first-in first-out) area called ReQue. The requests are signals requiring storing the stream. The HDD interface 220 stores the received stream in a relevant area inside the HDD 120 according to a kind of the request stored in an address (ReQue[i]) of the request FIFO area. At this point, the file mapping table stored inside the HDD 120 is updated.

In other words, the HDD interface 220 checks whether the FIFO area is empty (S401), and if it is judged that requests are stored in the FIFO area, a request stored in the address (ReQue[i]) of a current FIFO is read (S402). After that, whether the read request represents a broadcasting stream or a stream (a program stream) from an external apparatus, is judged (S403).

If the request is judged to represent a broadcasting stream, a transport stream output from the download control part 202, a video feature and an index file output from the index generating/VF extracting means 203, are stored in relevant areas of the HDD 120, respectively, on the basis of an address included in the index file (S404). In the meantime, if the request is judged to represent a stream (a message stream) provided from the external apparatus, a stream output from the external signal processing part 210 is stored in a message stream area of the HDD 120 (S405). After that, the HDD interface 220 performs the above steps staring from S401 to check and read a request stored in the next address of the ReQue FIFO.

A time stamp must be included in the broadcasting stream so that the upload control part 230 may output the broadcasting stream stored in the HDD 120 in a constant bit rate. The time stamp, however, is not included in the message stream. An output bit rate of the message stream is controlled by an A/V decoder or an MPEG decoder, or a buffer of a PVR output terminal controls the output bit rate of the message stream on the basis of an SCR (system clock reference) value or a reference clock value included in the message stream. Also, a video feature and an index file that correspond to the message stream are not detected/generated.

If data is received from an external apparatus while a user is out, the PVR controller 300 stores the received data in the HDD 120. At this point, the PVR controller 300 displays a message informing that the data is stored in the HDD 120, on an OSD (on screen display). Therefore, a user can check an absent-subscriber-message.

The present invention can be applied to a field related to an additional function of a PVR mounting a hard disk and a field of a home network system including a visual telephone and an intercommunication system.

As described above, the PVR apparatus according to the present invention can store and search data provided from a visual telephone and an intercommunication system as well as a digital TV program. Therefore, a visual telephone message and a visitor image that are received while a user is out can be checked.

It will be apparent to those skilled in the art that various modifications and variations can be made in the present invention. Thus, it is intended that the present invention covers the modifications and variations of this invention provided they come within the scope of the appended claims and their equivalents.

1. A personal video recorder (PVR) comprising:
a broadcasting signal processing part for detecting a video feature from a received broadcasting stream and generating an index file having the detected video feature;
an external signal processing part for converting a signal provided from an external image apparatus, into an MPEG (moving picture experts group) stream; and
a controller for storing, in predetermined areas inside a storing means, the broadcasting stream and the index file provided from the broadcasting signal processing part, and the MPEG stream provided from the external signal processing part, respectively.

2. The PVR of claim 1, wherein the broadcasting signal processing part comprises:
a decoder for detecting an elementary stream in the broadcasting stream;
an index generating/VF (video feature) extracting means for detecting a video feature from the detected elementary stream and generating an index file having the detected video feature; and
a download control part for adding a time stamp to the broadcasting stream provided from the decoder.

3. The PVR of claim 2, wherein the download control part adds a time stamp to the broadcasting stream on the basis of a clock reference included in the broadcasting stream.

4. The PVR of claim 1, wherein the video feature comprises at least either of an image's capacity and an image's type included in the broadcasting stream.

5. The PVR of claim 1, wherein the index file further comprises a storing address of the broadcasting stream.

6. The PVR of claim 1, wherein the external signal processing part comprises:
a transcoder for converting a signal provided from a visual telephone into an MPEG stream; and
an encoder for converting a signal provided from an intercommunication system, into an MPEG stream.

7. The PVR of claim 1, wherein the controller comprises:
an interface for storing, in a storing means, the broadcasting stream and the index file provided from the broadcasting signal processing part, and the MPEG stream provided from the external signal processing part;
an upload control part for outputting, in a predetermined bit rate, the stream stored in the storing means.

8. The PVR of claim 1, wherein the controller outputs the broadcasting stream stored in the storing means in a bit rate based on a time stamp added to the broadcasting stream.

9. The PVR of claim 1, wherein the controller outputs the MPEG stream stored in the storing means in a bit rate based on a clock reference included in the MPEG stream.

10. A method for controlling a personal video recorder (PVR), comprising the steps of:
detecting a video feature from a received broadcasting stream and generating an index file having the detected video feature;
adding a time stamp to the broadcasting stream;
converting a signal provided from an external image apparatus, into an MPEG (moving picture experts group) stream; and
storing, in predetermined areas inside a storing means, the broadcasting stream to which the time stamp is added, the index file, and the MPEG stream, respectively.

11. The method of claim 10, wherein the video feature comprises at least either of an image's capacity and an image's type included in the broadcasting stream.

12. The method of claim 10, wherein the index file further comprises a storing address of the broadcasting stream.

13. The method of claim 10, further comprising the step of:
outputting the broadcasting stream stored in the storing means, in a bit rate based on the time stamp added to the broadcasting stream.

14. The method of claim 10, further comprising the step of:
outputting the MPEG stream stored in the storing means, in a bit rate based on a clock reference included in the MPEG stream.

15. A personal video recorder (PVR) comprising:
a broadcasting processing part for converting a received broadcasting signal into a broadcasting stream;
an external signal processing part for converting a signal provided from an external image apparatus, into an MPEG (moving picture experts group) stream; and
a controller for storing, in a storing means, the broadcasting stream to which a time stamp is added and the MPEG stream, outputting the broadcasting stream stored in the storing means in a bit rate based the time stamp added to the broadcasting stream, and outputting the MPEG stream stored in the storing means in a bit rate based on a clock reference included in the MPEG stream.

16. The PVR of claim 15, wherein the controller detects a video feature from the broadcasting stream provided from the broadcasting signal processing part and generates an index file including the detected video feature.

17. The PVR of claim 16, wherein the video feature comprises at least either of an image's capacity and an image's type included in the broadcasting stream.

18. The PVR of claim 16, wherein the index file further comprises a storing address of the broadcasting stream.

19. A method for controlling a private video recorder (PVR), comprising the steps of:
adding a time stamp to a received broadcasting stream;
storing the broadcasting stream to which a time stamp is added, in a storing means;
converting a signal provided from an external image apparatus, into an MPEG (moving picture experts group) stream, and storing the same in the storing means;
outputting the broadcasting stream stored in the storing means, in a bit rate based on the time stamp added to the broadcasting stream; and
outputting the MPEG stream stored in the storing means, in a bit rate based on a clock reference included in the MPEG stream.

20. The method of claim 18, further comprising the steps of:
detecting a video feature from the broadcasting stream; and
generating an index file having the detected video feature.
